(19) United States
(12) Patent Application Publication
(10) Pub. No.: US 2014/0163700 A1
(43) Pub. Date: Jun. 12, 2014

(54) CONTROL DEVICE, CONTROL METHOD AND RELATED POWER MANAGEMENT SYSTEM

(71) Applicant: ANPEC ELECTRONICS CORPORATION, Hsin-Chu (TW)

(72) Inventors: Ching-Feng Lai, Taipei City (TW); Chih-Heng Su, Hsinchu City (TW)

(73) Assignee: ANPEC ELECTRONICS CORPORATION, Hsin-Chu (TW)

(21) Appl. No.: 13/775,081

(22) Filed: Feb. 22, 2013

(30) Foreign Application Priority Data
Dec. 12, 2012 (TW) 101146974

(51) Int. Cl. G05B 19/02

(52) U.S. Cl. CPC G05B 19/02
USPC 700/22

(57) ABSTRACT

A control device for controlling a power management system to enter an operating mode includes a power converting device, for providing input power for the control device; an operating mode control signal, for controlling the power management system to enter the operating mode, wherein the operating mode control signal is a first signal of the power management system; and an operating result displaying signal, for displaying at least one operating result in the operating mode, wherein the operating result displaying signal is a second signal of the power management system.

### BACKGROUND OF THE INVENTION

1. Field of the Invention

The present invention relates to a device and method capable of controlling a power management system to enter an operating mode and a related power management system, and more particularly, to a device and method capable of controlling a power management system to enter an operating mode in a hardware manner, and a related power management system, where the device and method control the power management system to enter the operating mode only by utilizing control signals of the power management system without using complex program languages or software.

2. Description of the Prior Art

In recent years, over-current protection devices have become one of the basic requirements of a power management system. In order to achieve stability of the over-current protection device, the power management system has to perform tests to ensure the current for triggering the over-current status is accurate enough. For an illustration of this, please refer to FIG. 1, which is a schematic diagram of an over-current protection device 10 of a conventional power management system. As shown in FIG. 1, the over-current protection device 10 comprises a comparator 102, a sensing resistor Rₛₑₙ, a compensation resistor R_{offset}, a variable resistor Rᵥₐᵣ and a current source Iₛᵢₙₖ. A positive input terminal and a negative input terminal of the comparator 102 are coupled to two terminals of the sensing resistor Rₛₑₙ, respectively, for comparing voltages of the two terminals of the sensing resistor Rₛₑₙ. The sensing resistor Rₛₑₙ is utilized for detecting an output current Iₒᵤₜ of the power management system. The compensation resistor R_{offset} is further connected in series between the negative input terminal of the comparator 102 and the sensing resistor Rₛₑₙ. The current source Iₛᵢₙₖ is connected to the compensation resistor R_{offset}, such that a voltage difference between these two terminals of the compensation resistor R_{offset} is generated, in order to compensate a voltage V_{N} of the negative input terminal of the comparator 102. The voltage V_{P} of the positive input terminal and the voltage V_{N} of the negative input terminal of the comparator 102 can therefore be compared. An output terminal of the comparator 102 generates an over-current signal V_{OCP} according to the comparing result of the voltage V_{P} and the voltage V_{N}.

Under a normal operation of the over-current protection device 10, the voltage V_{P} may be greater than the voltage V_{N} when the output current Iₒᵤₜ is zero or an extremely small value. When the output current Iₒᵤₜ increases gradually, the voltage difference V_{P}−V_{N} between the positive input terminal and the negative input terminal may be reduced gradually. When the output current Iₒᵤₜ exceeds a threshold value, the voltage V_{P} decreases to be less than the voltage V_{N}, such that the over-current signal V_{OCP} is triggered and changes its status. If an over-current protection with 10A current is required by the power management system, the values of the sensing resistor Rₛₑₙ, the compensation resistor R_{offset} and the current source Iₛᵢₙₖ can be set in order to achieve V_{P}=V_{N} when Iₒᵤₜ=10A. Since errors may exist in the process, however, for each over-current protection device having the same circuit structure, the over-current signal V_{OCP} may be triggered at different currents Iₒᵤₜ, rather than being triggered at an accurate and fixed current Iₒᵤₜ. If an over-current protection with 10A current is required by the power management system, each chip is tested by varying the output current Iₒᵤₜ practically, and the status of the over-current signal V_{OCP} may not change at Iₒᵤₜ=10A exactly. Instead, it may change at other currents such as 9.5 A or 10.5 A. This error may come from a mismatch between the positive input terminal and the negative input terminal of the comparator 102, errors in the resistance values of the sensing resistor Rₛₑₙ and the compensation resistor R_{offset}, or errors in the current value of the current source Iₛᵢₙₖ, etc. In order to compensate for this, a variable resistor Rᵥₐᵣ can be connected to the compensation resistor R_{offset} in series. The resistance value of the variable resistor Rᵥₐᵣ can be adjusted manually, in order to correct the error in the trigger point of the over-current signal V_{OCP}. Therefore, the over-current signal V_{OCP} can change its status at Iₒᵤₜ=10A, and thereby achieve a stable over-current protection.

When the power management system is produced, a large quantity of devices is needed to perform the over-current test. In order to improve production efficiency, the industry has developed an automatic test system, which is capable of controlling the power management system to enter a test mode and testing each of the over-current protection devices in each power management system to determine whether these over-current protection devices are accurate. The trigger point for the over-current signal V_{OCP} is then adjusted automatically and internally. In general, the method for controlling the power management system to enter the automatic test mode is achieved by using program languages (e.g. C language) or software (e.g. LabVIEW). The procedures of controlling the power management system by software or program languages are rather complex, however, such that production processes cannot be reduced effectively and production efficiency can not be enhanced. Thus, there is need for improvement over the prior art.

### SUMMARY OF THE INVENTION

It is therefore an objective of the present invention to provide a control device, a control method and a related power management system capable of controlling the power management system to enter an operating mode in a hardware manner, where the control device and method control the power management system to enter the operating mode only by utilizing control signals of the power management system without using complex program languages or software.

The present invention discloses a control device for controlling a power management system to enter an operating mode. The control device comprises a power converting device, for providing input power for the control device; an operating mode control signal, for controlling the power management system to enter the operating mode, wherein the operating mode control signal is a first signal of the power management system; and an operating result displaying signal, for displaying at least one operating result in the operating mode, wherein the operating result displaying signal is a second signal of the power management system.

The present invention further discloses a controlling method for controlling a power management system to enter an operating mode. The controlling method comprises controlling the power management system to enter the operating mode by controlling a first signal of the power management system; and displaying at least one operating result in the operating mode by using a second signal of the power management system.

The present invention further discloses a power management system comprising an over-current protection module and a control device. The over-current protection module comprises an over-current detecting device; and a compensation device, for compensating an error of an over-current threshold value detected by the over-current detecting device. The control device is utilized for controlling the power management system to enter an automatic test mode, in order to perform an over-current protection test. The control device comprises a power converting device, for providing input power for the control device; an operating mode control signal, for controlling the power management system to enter the automatic test mode, wherein the operating mode control signal is a first signal of the power management system; and an operating result displaying signal, for displaying at least one operating result in the automatic test mode, wherein the operating result displaying signal is a second signal of the power management system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an over-current protection device of a conventional power management system.

FIG. 2 is a schematic diagram of an over-current protection device according to an embodiment of the present invention.

FIG. 3 is a schematic diagram of an automatic test system according to an embodiment of the present invention.

FIG. 4 is a waveform diagram of the automatic test system controlling the power management system to operate in the automatic test mode.

FIG. 5 is a waveform diagram of the automatic test system controlling the power management system to operate in another automatic test mode.

FIG. 6 is a schematic diagram of an automatic test process according to an embodiment of the present invention.

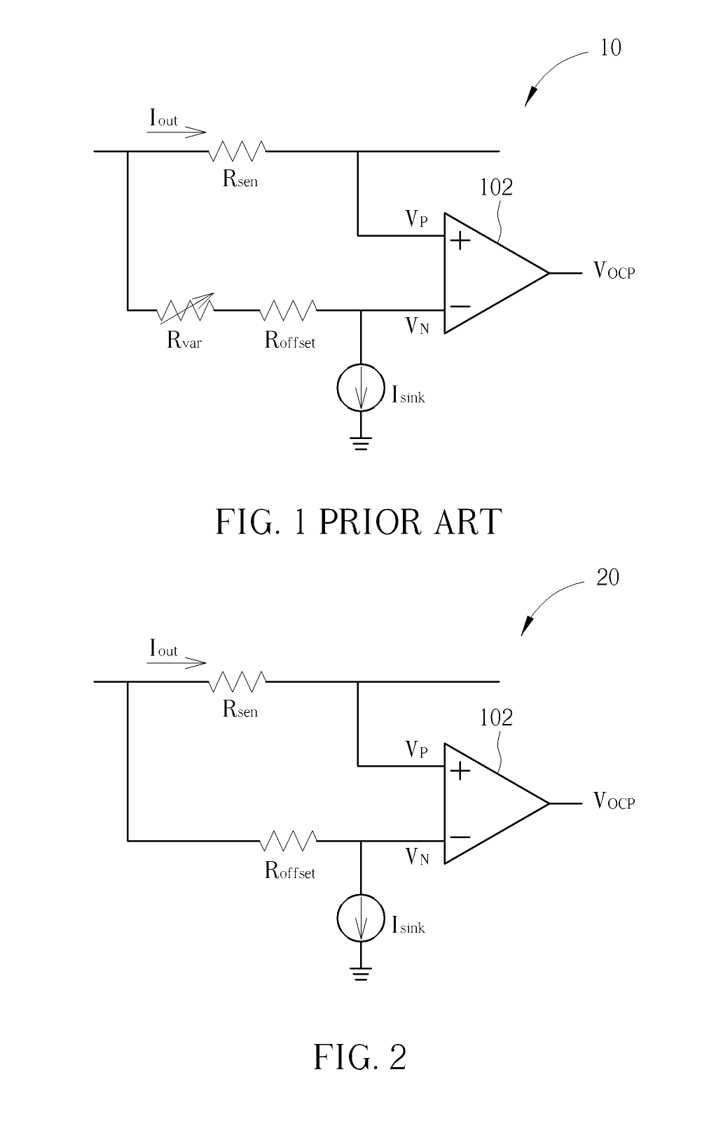

### DETAILED DESCRIPTION

Please refer to FIG. 2, which is a schematic diagram of an over-current protection device 20 according to an embodiment of the present invention. As shown in FIG. 2, the structure of the over-current protection device 20 is similar to that of the over-current protection device 10, wherein both over-current protection devices are utilized in a power management system for over-current protection; thus elements or signals with similar functions are denoted by the same symbols and numerals. The main difference between the over-current protection device 20 and the over-current protection device 10 is that the over-current protection device 20 does not include the variable resistor Rᵥₐᵣ. Therefore, when an error occurs in the trigger point of the over-current signal V_{OCP}, the over-current protection device 20 does not adjust the resistance value of the variable resistor Rᵥₐᵣ manually to adjust the trigger point of the over-current signal V_{OCP}. Instead, the over-current protection device 20 adjusts the magnitude of the current source Iₛᵢₙₖ internally and automatically, in order to correct the error in the trigger point of the over-current signal V_{OCP}. Therefore, the over-current signal V_{OCP} can change its status accurately, in order to achieve a stable over-current protection.

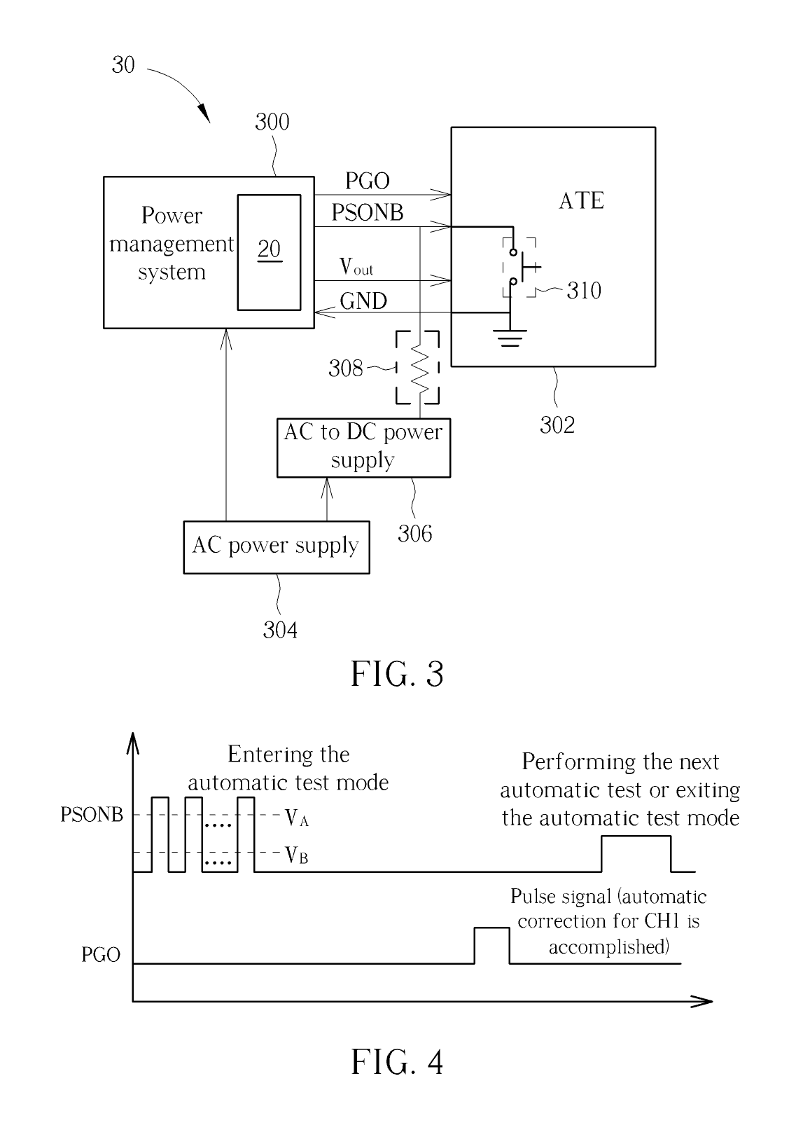

Please refer to FIG. 3, which is a schematic diagram of an automatic test system 30 according to an embodiment of the present invention. As shown in FIG. 3, the automatic test system 30 performs an over-current protection test and automatic correction on the over-current protection device 20 of a power management system 300, in order to ensure that the over-current signal V_{OCP} can be triggered at a fixed over-current value. The automatic test system 30 includes an automatic test equipment (ATE) 302, an alternating current (AC) power supply 304, an alternating current to direct current (DC) power supply 306 and a pull-high resistor 308. The ATE 302 is utilized for performing the over-current protection test on the power management system 300. Signal transmission between the ATE 302 and the power management system 300 includes an output voltage Vₒᵤₜ and a ground terminal GND. In addition, the power management system 300 further outputs a power-on signal PSONB and a power good signal PGO to the ATE 302. The power-on signal PSONB is utilized for controlling the power management system 300 to be turned on or off, and the power good signal PGO is utilized for displaying whether the output voltage Vₒᵤₜ of the power management system 300 reaches a sufficient voltage level and can be a DC voltage source. The AC power supply 304 is utilized for providing input power for the power management system 300. The AC to DC power supply 306, coupled to the AC power supply 304, is utilized for generating a DC power. The pull-high resistor 308, coupled to the AC to DC power supply 306, receives the DC power outputted by the AC to DC power supply 306 and is utilized for pulling the power-on signal PSONB to a higher voltage level.

In detail, when the automatic test system 30 starts to perform the over-current protection test on the over-current protection device 20, the power-on signal PSONB may control the over-current protection device 20 to enter the automatic test mode, in order to perform automatic test and automatic correction on the over-current protection device 20. In some embodiments, the ATE 302 may input a specific type of control signal in the power-on signal PSONB, in order to control the power management system 300 to enter the automatic test mode. For example, please refer to FIG. 4, which is a waveform diagram of the automatic test system 30 controlling the power management system 300 to operate in the automatic test mode. As shown in FIG. 4, the pull-high resistor 308 pulls the power-on signal PSONB to a voltage level higher than a high voltage level V_{A} when the automatic test system 30 is activated; hence a driving device 310 of the ATE 302 can be utilized for driving the power-on signal PSONB to a voltage level lower than a low voltage level V_{B} several times consecutively, in order to generate several consecutive pulse signals. The automatic test system 30 then detects the power-on signal PSONB. When several consecutive pulse signals are generated in the power-on signal PSONB and the higher voltage level of the pulse signals is higher than V_{A} and the lower voltage level of the pulse signals is lower than V_{B}, the automatic test system 30 controls the power management system 300 to enter the automatic test mode, and starts to perform automatic test and automatic correction on the over-current protection device 20.

Please note that the method of controlling the power management system 300 to enter the automatic test mode should possess a certain entering difficulty or complexity; therefore, when the power management system 300 is interfered with by noise or the control device is touched by a user accidentally, the power management system 300 may not be easily misled to enter the automatic test mode. In comparison with the conventional method of using the program languages or software, the method of entering the automatic test mode based on the embodiments of the present invention is more simple, but still has a certain difficulty, in order to prevent the power management system 300 from entering the automatic test mode accidentally to affect the operations under normal usage. For example, the high voltage level V_{A} may be designed to be a higher voltage level which the power-on signal PSONB may not reach under normal operation of the power management system 300, or the low voltage level V_{B} may be designed to be a lower voltage level which the power-on signal PSONB may not reach under normal operation of the power management system 300, such that the power management system 300 may not enter the automatic test mode easily under normal operation. For the power-on signal PSONB, the number of continuous pulse signals may also be adjusted, such that when the number of consecutive pulse signals exceeds a proper number, the power management system 300 will enter the automatic test mode. If the number is too small, the power management system 300 may easily be triggered by accident to enter the automatic test mode more; if the number is too large, the length of the control signal may be too long, which may reduce efficiency of the automatic test.

After the automatic test mode is activated, the power-on signal PSONB may remain in a lower voltage level, in order to control the power management system 300 to remain in the automatic test mode. At this moment, the over-current protection device 20 starts to perform automatic test and automatic correction, and displays a signal representing the completion of correction after the automatic correction is accomplished. In detail, the automatic test system 30 can display the signal representing the completion of correction by using the power good signal PGO. As shown in FIG. 4, the power good signal PGO remains in a lower voltage level when the power management system 300 enters the automatic test mode, and a pulse signal is generated in the power good signal PGO after automatic test and automatic correction for the over-current protection device 20 are accomplished, which means that the automatic correction is accomplished successfully.

In some embodiments, the power management system 300 includes more than one over-current protection device; hence the ATE 302 has to perform automatic test and automatic correction on different over-current protection devices. At this moment, the power good signal PGO has to display the automatic correction statuses of over-current protection devices on different channels by using different methods. For example, assuming that the power management system 300 includes two over-current protection devices located in channels CH1 and CH2, respectively, the power good signal PGO can generate different numbers of pulse signals to represent the completion of automatic correction for the over-current protection devices on different channels. For example, the completion of automatic correction for the over-current protection device on the channel CH1 may be denoted by one pulse signal, and the completion of automatic correction for the over-current protection device on the channel CH2 may be denoted by two consecutive pulse signals. As shown in FIG. 4, one pulse signal is generated in the power good signal PGO, which represents that automatic correction for the over-current protection device on the channel CH1 is accomplished. As a result, the automatic test system 30 can display the automatic correction statuses for the over-current protection devices on more channels by generating different numbers of pulse signals. The automatic correction statuses of multiple over-current protection devices may also be displayed by generating signals with different amplitudes or different lengths, which is not limited herein.

In some embodiments, after the automatic correction for the over-current protection device on the channel CH1 is accomplished and the status is displayed on the power good signal PGO, the automatic test system 30 may also generate a specific type of signal in the power-on signal PSONB, in order to represent that next automatic correction process for the over-current protection device on the channel CH2 is started. Another specific type of signal can be generated in the power-on signal PSONB, in order to control the power management system 300 to exit the automatic test mode. For example, as shown in FIG. 4, after the power good signal PGO displays that automatic correction for some over-current protection devices has been accomplished, the automatic test system 30 can generate a pulse signal which is longer and located in a middle voltage level in the power-on signal PSONB, in order to control the power management system 300 to perform next automatic test and automatic correction, or control the power management system 300 to exit the automatic test mode.

Please note that the spirit of the present invention is to control a power management system to enter an automatic test mode only by utilizing control signals of the power management system without using complex program languages or software. Those skilled in the art can make modifications and alterations accordingly. For example, the power-on signal PSONB shown in FIG. 4 remains in a lower voltage level in the automatic test mode, and positive pulse signals are utilized for controlling the power management system 300 to perform next automatic test or to exit the automatic test mode. In other embodiments, for the automatic test mode, the power-on signal PSONB may remain in a higher voltage level, and negative pulse signals or other types of control signals can be utilized for controlling the operations of the power management system 300, which are not limited herein.

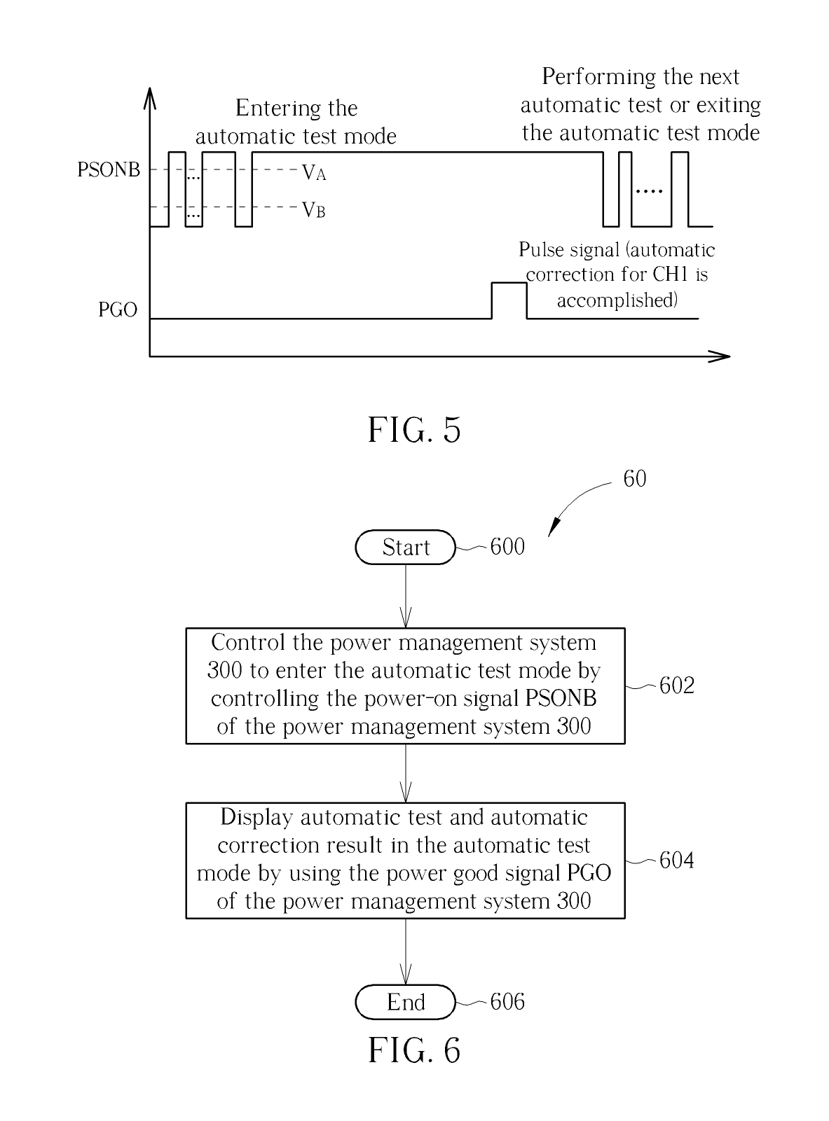

Please refer to FIG. 5, which is a waveform diagram of the automatic test system 30 controlling the power management system 300 to operate in another automatic test mode. As shown in FIG. 5, for the automatic test mode, the power-on signal PSONB remains in a higher voltage level. Control signals for controlling the power management system 300 to enter a next automatic test or to exit the automatic test mode are also different from those shown in FIG. 4. As can be seen, the types of control signals in the power-on signal PSONB are not limited to those illustrated in the above embodiments, i.e. no matter which type of control signal is utilized, as long as the control signal can be utilized for controlling the power management system 300 to perform any operations related to automatic test, the method is within the scope of the present invention.

The above operations of the automatic test system 30 can be summarized into an automatic test process 60, as shown in FIG. 6. The automatic test process 60 includes the following steps:

Step 600: Start.

Step 602: Control the power management system 300 to enter the automatic test mode by controlling the power-on signal PSONB of the power management system 300.

Step 604: Display automatic test and automatic correction result in the automatic test mode by using the power good signal PGO of the power management system 300.

Step 606: End.

Detailed operations related to the automatic test process 60 are illustrated above, and will not be narrated herein.

In the prior art, program languages or software are always utilized for controlling a power management system to enter an automatic test mode. The procedures are rather complex, such that production processes cannot be reduced effectively and production efficiency cannot be enhanced. In comparison, the present invention can utilize control signals of a power management system to control the power management system to enter the automatic test mode in a hardware manner. As a result, the process of the power management system entering the automatic test mode can be simplified, thereby enhancing the efficiency of automatic test, which further enhances production efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control device for controlling a power management system to enter an operating mode, the control device comprising:
a power converting device, for providing input power for the control device;
an operating mode control signal, for controlling the power management system to enter the operating mode, wherein the operating mode control signal is a first signal of the power management system; and
an operating result displaying signal, for displaying at least one operating result in the operating mode, wherein the operating result displaying signal is a second signal of the power management system.

2. The control device of claim 1, wherein the first signal is a power-on signal.

3. The control device of claim 1, wherein the second signal is a power good signal.

4. The control device of claim 1, wherein the operating mode is an automatic test mode.

5. The control device of claim 4, wherein an over-current protection test is performed in the power management system in the automatic test mode, in order to test whether an over-current threshold value is accurate.

6. The control device of claim 5, wherein the power management system adjusts the over-current threshold value internally when the over-current threshold value is not accurate.

7. The control device of claim 5, wherein the operating result displaying signal displays that an operating result among the operating results is accomplished when the over-current threshold value is accurate.

8. The control device of claim 1, wherein the control device inputs a first signal type in the operating mode control signal, in order to control the power management system to enter the operating mode.

9. The control device of claim 8, wherein the first signal type is a plurality of pulse signals.

10. The control device of claim 8, wherein the control device inputs a second signal type in the operating mode control signal, in order to control the power management system to enter another operating mode.

11. The control device of claim 8, wherein the control device inputs a third signal type in the operating mode control signal, in order to control the power management system to exit the operating mode.

12. The control device of claim 1, further comprising a pull-high resistor, coupled to the operating mode control signal, for pulling high a voltage level of the operating mode control signal.

13. A controlling method for controlling a power management system to enter an operating mode, the controlling method comprising:
controlling the power management system to enter the operating mode by controlling a first signal of the power management system; and
displaying at least one operating result in the operating mode by using a second signal of the power management system.

14. The controlling method of claim 13, wherein the first signal is a power-on signal.

15. The controlling method of claim 13, wherein the second signal is a power good signal.

16. The controlling method of claim 13, wherein the operating mode is an automatic test mode.

17. The controlling method of claim 16, wherein an over-current protection test is performed in the power management system in the automatic test mode, in order to test whether an over-current threshold value is accurate.

18. The controlling method of claim 17, wherein the power management system adjusts the over-current threshold value internally when the over-current threshold value is not accurate.

19. The controlling method of claim 17, wherein the operating result displaying signal displays that an operating result among the operating results is accomplished when the over-current threshold value is accurate.

20. The controlling method of claim 13, wherein the control device inputs a first signal type in the operating mode control signal, in order to control the power management system to enter the operating mode.

21. The controlling method of claim 20, wherein the first signal type is a plurality of pulse signals.

22. The controlling method of claim 20, wherein the control device inputs a second signal type in the operating mode control signal, in order to control the power management system to enter another operating mode.

23. The controlling method of claim 20, wherein the control device inputs a third signal type in the operating mode control signal, in order to control the power management system to exit the operating mode.

24. The controlling method of claim 13, further comprising a pull-high resistor, coupled to the operating mode control signal, for pulling high a voltage level of the operating mode control signal.

25. A power management system, comprising:
an over-current protection module, comprising:
an over-current detecting device; and
a compensation device, for compensating an error of an over-current threshold value detected by the over-current detecting device; and
a control device, for controlling the power management system to enter an automatic test mode, in order to perform an over-current protection test, the control device comprising:
a power converting device, for providing input power for the control device;
an operating mode control signal, for controlling the power management system to enter the automatic test mode, wherein the operating mode control signal is a first signal of the power management system; and
an operating result displaying signal, for displaying at least one operating result in the automatic test mode, wherein the operating result displaying signal is a second signal of the power management system.

26. The power management system of claim 25, wherein the first signal is a power-on signal.

27. The power management system of claim 25, wherein the second signal is a power good signal.

28. The power management system of claim 25, wherein the power management system adjusts the over-current threshold value internally when the over-current threshold value is not accurate.

29. The power management system of claim 25, wherein the operating result displaying signal displays that an operating result among the operating results is accomplished when the over-current threshold value is accurate.

30. The power management system of claim 25, wherein the control device inputs a first signal type in the operating mode control signal, in order to control the power management system to enter the operating mode.

31. The power management system of claim 30, wherein the first signal type is a plurality of pulse signals.

32. The power management system of claim 30, wherein the control device inputs a second signal type in the operating mode control signal, in order to control the power management system to enter another operating mode.

33. The power management system of claim 30, wherein the control device inputs a third signal type in the operating mode control signal, in order to control the power management system to exit the operating mode.

34. The power management system of claim 25, further comprising a pull-high resistor, coupled to the operating mode control signal, for pulling high a voltage level of the operating mode control signal.
